(19) United States
(12) Patent Application Publication
(10) Pub. No.: US 2017/0074339 A1
(43) Pub. Date: Mar. 16, 2017

(54) BRAKE DISC INCLUDING WEAR INDICATING MEANS

(71) Applicant: Hyundai Motor Company, Seoul (KR)

(72) Inventors: Jae Hun SHIM, Hwaseong-si (KR); Bong Soo KIM, Hwaseong-si (KR); Sang Hyun SHIM, Seoul (KR); Gab Bae JEON, Hwaseong-si (KR); Joung Hee LEE, Suwon-si (KR)

(73) Assignee: Hyundai Motor Company, Seoul (KR)

(21) Appl. No.: 15/221,387

(22) Filed: Jul. 27, 2016

(30) Foreign Application Priority Data
Sep. 11, 2015 (KR) 10-2015-0128992

(51) Int. Cl. F16D 66/02; F16D 65/12

(52) U.S. Cl. CPC F16D 66/02; F16D 65/126; F16D 2200/0052; F16D 2200/0039

(57) ABSTRACT

A carbon-ceramic disc provided with friction surfaces on both surfaces of a load part at a center of the disc may include a wear indicating device formed on the friction surfaces, wherein a wear indicating recess as the wearing indicating device is formed along a virtual circular line between a contact surface contacting with a pad, and a non-contact surface not contacting with the pad in the carbon-ceramic disc, and wherein the virtual circular line is formed on the friction surface of the carbon-ceramic disc to pass through a center point of a width of the wear indicating recess.

### CROSS-REFERENCE TO RELATED APPLICATION

The present application claims priority to Korean Patent Application No. 10-2015-0128992 filed on Sep. 11, 2015, the entire contents of which is incorporated herein for all purposes by this reference.

### BACKGROUND

Field of the Invention

The present invention relates to a brake disc for a vehicle. More particularly, it relates to a brake disc including a wear life indicating means, which is improved so that a user is capable of easily checking a wear limit of a brake lining visually or by touch.

Description of Related Art

In general, a brake device, which is a braking device for a vehicle, is an important device of a vehicle used for decelerating or stopping a travelling vehicle, and a disc brake and a drum brake which are a hydraulic brake are used, and recently, the disc brake has been mainly used compared to the drum brake in order to improve braking performance of a vehicle, and the disc brake is a device, which makes a brake pad contact a disc to brake a vehicle.

The disc brake brakes a vehicle by pressing a brake pad at both sides of the brake disc, which is rotated together with wheels, with hydraulic pressure. The disc brake includes a disc, which is coupled with a wheel hub and is rotated together with the wheel, a caliper, which is fixedly mounted to a vehicle body so as to surround an outer peripheral surface of one side of the disc, a brake pad, which is adjacently disposed to the disc within the caliper and is selectively in contact with the disc to generate frictional braking force, a hydraulic cylinder, which pressurizes the pad toward the disc, and the like.

The kind of brake disc includes a cast iron disc, which has been used in the related art, and a carbon-ceramic disc, and the cast iron disc has a large wear quantity because of low wear resistance, and is formed of a single material, so that a correlation between a thickness decrease and a durability life thereof is low, and the carbon-ceramic disc has a small wear quantity because of high wear resistance, and a durability life thereof is limited according to a thickness of a friction surface. Recently, in order to decrease weight of a vehicle, the carbon-ceramic disc is increasingly used.

The brake pad in the disc brake continuously rubs against the brake disc while braking the vehicle and is worn, so that it is necessary to replace the disc and the brake pad at an appropriate time for a normal operation of a brake system.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARYBRIEF SUMMARY

Various aspects of the present invention are directed to providing a wear indicating part in the carbon-ceramic disc in the related art, and provide a carbon-ceramic disc including a wear indicating means having an improved structure, in which a disc friction surface is uniform, which does not generate abnormal vibration and abnormal noise, and which enables a user to more accurately predict a replacement time of a disc visually or by touch.

In one aspect, the present invention provides a carbon-ceramic disc, which is provided with friction surfaces on both surfaces of a load part at a center of the disc, and includes a wear indicating means formed on the friction surfaces, in which wear indicating recesses as the wearing indicating means are formed along a virtual circular line at a boundary point between a contact surface, which is in contact with the pad, and a non-contact surface in the carbon-ceramic disc, and the virtual circular line is formed on the friction surface of the carbon-ceramic disc so as to pass through a center point of a width of the wear indicating recess.

In an exemplary embodiment, the wear indicating recesses may be circularly formed along the virtual circular line at the boundary point between the contact surface and the non-contact surface of the pad in the friction surface of the carbon-ceramic disc.

In another exemplary embodiment, the wear indicating recesses may be arranged along the virtual circular line at the boundary point between the contact surface and the non-contact surface of the pad in the friction surface of the carbon-ceramic disc at the same interval as the plurality of wear indicating recesses formed in any one shape selected from a quadrangular shape, a circular shape, and a triangular shape.

In still another exemplary embodiment, the wear indicating recesses may be formed with a depth of 30 to 40% of a thickness of the friction surface, and may be formed so that widths of the wear indicating recesses pass the virtual circular line at the boundary point between the contact surface of the pad, which is in contact with the friction surface, and the non-contact surface of the pad by ½.

In yet another exemplary embodiment, the load part and the friction surfaces formed on both side surfaces of the load part may be formed of a composition of carbon and ceramic, and a ceramic concentration of the load part may be larger than a ceramic concentration of the friction surface, but a carbon concentration of the friction surface may be larger than a carbon concentration of the load part.

According to the exemplary embodiment of the present invention, the wear indicating parts are formed to pass identical circles corresponding to an internal diameter and an external diameter of the pad rubbing against the carbon-ceramic brake disc, so that a driver may intuitively and very objectively measure a wear life limit of the carbon-ceramic disc through visual observation and through touch by a hand of a driver. Further, the wear indicating parts are formed along virtual circles corresponding to the internal diameter and the external diameter of the pad at a uniform interval while passing the virtual circles, so that degradation of a weight balance of the disc due to non-uniform wearing of the disc in the related art is not generated, and thus, the friction surface of the disc is uniform, abnormal vibration and abnormal noise are not generated, and it is possible to more accurately predict a replacement time of the disc visually or by touch.

Other aspects and exemplary embodiments of the invention are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The above and other features of the invention are discussed infra.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a perspective view schematically illustrating a brake disc adopting a carbon-ceramic disc in the related art;

FIG. 2 is a perspective view illustrating an example of a wear indicating means in the related art formed on a friction surface of the disc of FIG. 1;

FIG. 3 is a perspective view illustrating circular wear indicating recess formed along a virtual circular line corresponding to an internal diameter side and an external diameter side of a pad when the pad is in contact with a carbon-ceramic disc according to an exemplary embodiment of the present invention;

FIG. 4 is a cross-sectional view illustrating the circular wear indicating recess, which is formed along the virtual circular line corresponding to the internal diameter of the pad, taken along line A-A of FIG. 3; and

FIG. 5 is a top plane view illustrating a plurality of wear indicating recesses formed at the same interval along a virtual circular line corresponding to an internal diameter side of a pad when the pad is in contact with the carbon-ceramic disc as a modified example of the exemplary embodiment of FIG. 3.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

First, in order to help understand the present invention, a brake disc adopting an existing carbon-ceramic disc will be described below.

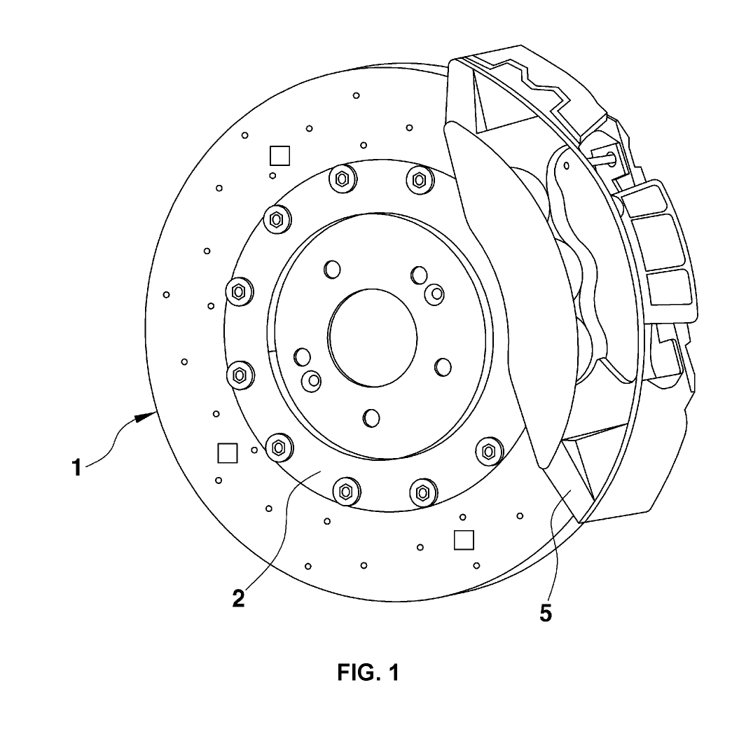

FIG. 1 illustrates a carbon-ceramic disc 1 as an example, and a hat part 2 formed of a heterogeneous material, that is, an aluminum material for radiating heat, is fastened to the disc through a separate fastening unit to be fastened with a wheel, and a caliper 5 is mounted so as to be engaged with both surfaces of the carbon-ceramic disc 1 and generate braking force.

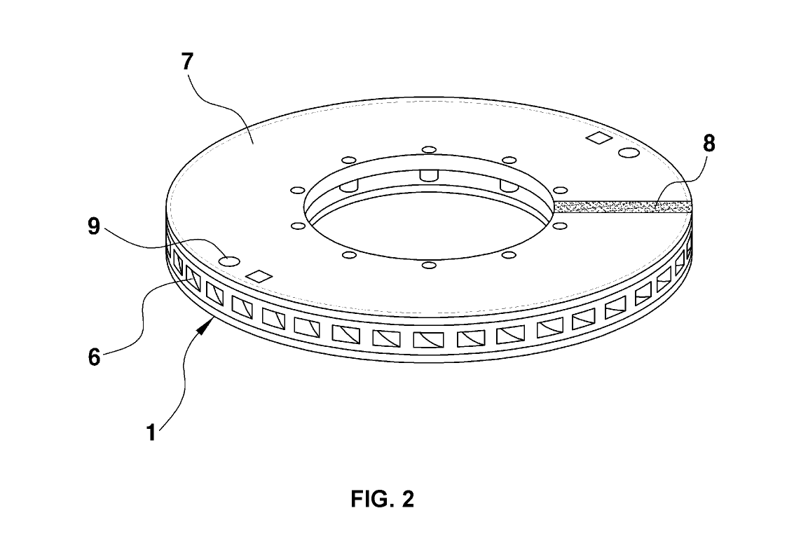

The carbon-ceramic disc includes an internal load part 6 and a friction surface 7 therein as schematically illustrated in FIG. 2, and a carbon-ceramic composition material is inserted into the friction surface in order to measure a durability life of the friction surface. A case where a shape of the composition material 8 is changed 50% or more from an initial shape is regulated as a wear life limit of the brake disc, and at this time, it is recommended to replace the brake disc, or a replacement time of the brake disc is determined by forming a plurality of indicating parts 9 shaped like a recess and visually checking a degree of wearing of the indicating part 9.

As another example, a brake disc for a vehicle disclosed in Korean Patent No. 10-1090823 (registered on Dec. 1, 2011) includes a base part having both circular lateral sides, friction parts coupled to both lateral sides of the base part with a predetermined thickness, respectively, and a wear indicating part, which is provided at a boundary region with the base part, which belongs to a wear limit of the friction part with a predetermined thickness, and has a different color or pattern from that of the friction part so as to be discriminated from the friction part visually, so that a case where the wear indicating part appears device that the friction part reaches a wear limit value, or the wear indicating part is formed from an external surface of the friction part in a depth direction and a case where the wear indicating part does not appear device that the friction part reaches a wear limit value, thereby predicting a current wear state.

However, the wear indicating part in the brake disc in the related art is non-uniformly formed and non-uniformly loses weight, thereby causing deterioration of weight balance of the brake disc and generating abnormal vibration and noise, and when the carbon-ceramic composition material is used, each of the drivers may have a different determination reference for a change of the composition material, so that when an accurate replacement time of the disc elapses, a big problem in safety may be caused.

Hereinafter, the present invention will be described in more detail with reference to the accompanying drawings illustrating an exemplary embodiment of the present invention.

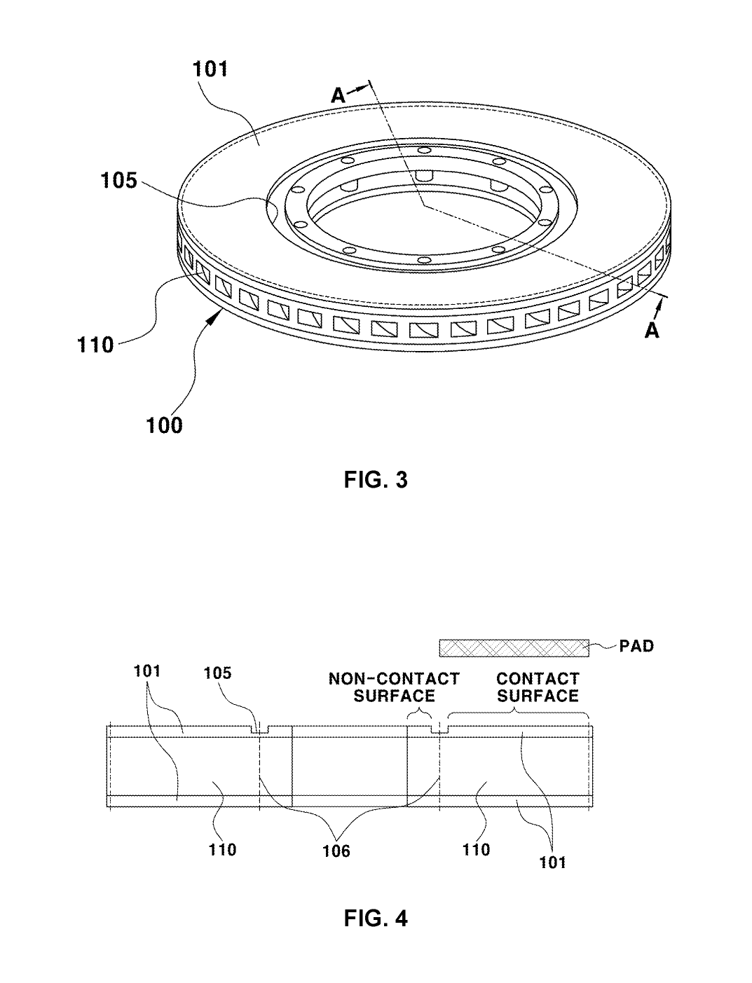

In FIG. 3, a carbon-ceramic disc 100 according to an exemplary embodiment of the present invention is provided with friction surfaces 101 on both surfaces of a load part 110 at a center of the disc, and the load part 110 and the friction surfaces 101 formed at both sides of the load part 110 are formed of a composition of carbon and ceramic. The load part requires larger strength than that of the friction surface, but the friction surface requires larger wear resistance and braking characteristic than those of the load part, so that a ceramic concentration of the load part is larger than that of the friction surface, but a carbon concentration of the friction surface is larger than that of the load part.

According to the exemplary embodiment of the present invention, wear indicating recess 105 is circularly formed on the friction surface 101 of the carbon-ceramic disc 100 as a wear indicating means.

As illustrated in FIGS. 3 and 4, the wear indicating recesses 105 are formed along a virtual circular line 106 (indicated by a dotted line to be adjacent to an internal end in the drawings) corresponding to an end of an internal diameter side of a pad, which is in contact with the disc, that is, the virtual circular line 106 of a boundary point between a contact surface of the disc contacting with the pad, and a non-contact surface of the disc not contacting with the pad, so that a width of the wear indicating recess 105 passes the virtual circular line 106, that is, the virtual circular line 106 passes through a center point of the wear indicating recess 105.

As described above, in the friction surface 101 of the carbon-ceramic disc, the wear indicating recess 105 is formed while passing the virtual circular line 106 at the boundary point between the contact surface and the non-contact surface of the pad, so that an external end of the wear indicating recess 105 is worn by the pad, but an internal end of the wear indicating recess 105 is not in contact with the pad and maintains an initial state, so that it is possible to easily and accurately check a wear state even visually by comparing the internal end of the wearing indicating recess, which is not in contact with the pad and maintains the initial state, with the external end of the wearing indicating recess, which is in contact with the pad and is worn.

A user or an operator may easily check a degree of wear even with a tactile sensation by touching the wear indicating recess with a hand and comparing the internal end of the wear indicating recess, which maintains the initial state, with the external end of the wear indicating recess, which is in contact with the pad and is worn.

The wear indicating recesses according to an exemplary embodiment of the present invention are circularly formed along the virtual circular line of the boundary point between the contact surface of the pad, which is in contact with the disc, and the non-contact surface of the pad, while passing the virtual circular line, so that the carbon-ceramic disc is uniformly worn by the pad and thus a weight balance degradation due to non-uniform wearing in the related art is not generated, and as a result, abnormal vibration and abnormal noise are not generated, and it is possible to more accurately predict a replacement time of the disc visually or by touch.

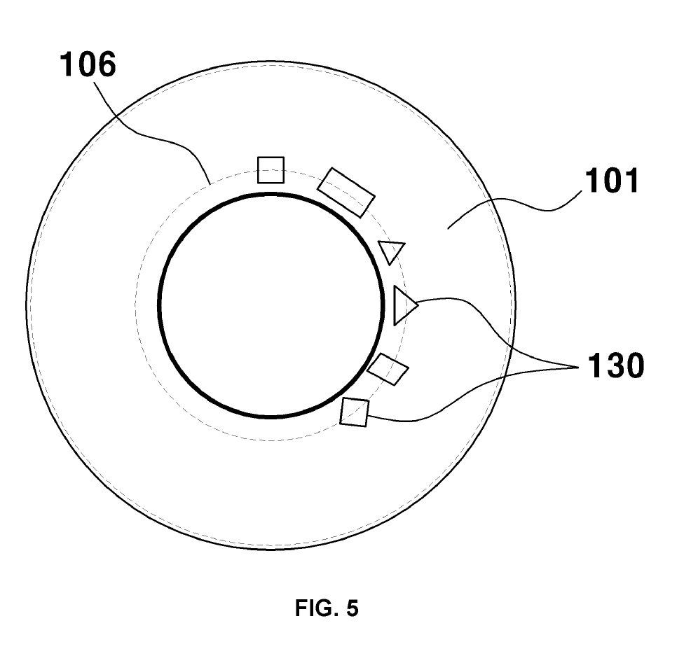

In a modified example of the present invention illustrated in FIG. 5, instead of circularly forming the wear indicating recesses 105 along the virtual circular line 106 at the boundary point between the contact surface and the non-contact surface of the pad in the carbon-ceramic disc in the exemplary embodiment illustrated in FIGS. 3 and 4, a plurality of small wear indicating recesses 130 is arranged at the same interval as the wear indicating means.

A shape of the wear indicating recess 130 may be any one selected from, for example, a circular shape, a triangular shape, a quadrangular shape, and an elliptical shape.

According to the modified example of the present invention, the plurality of wear indicating recesses 130 is spaced apart from each other at the same interval while passing the virtual circular line 106 at the boundary point between the contact surface and the non-contact surface of the pad, that is, the external part of the wear indicating recess 130 is formed on a surface of the disc which is in contact with the pad, and the internal part of the wear indicating recess 130 is formed on a surface of the disc which is not in contact with the pad, so that the operator may easily check a wearing state of the part, which is in contact with the pad, by comparing the part, which is in contact with the pad, with the internal part, which is not in contact with the pad and maintains an initial state, visually or by touch, and easily and accurately predict a replacement time of the disc.

The wear indicating recesses 105 and 130 are formed to have a smaller thickness than that of the friction surface, preferably, with a depth of 30 to 40% of the thickness of the friction surface. Further, the wear indicating recesses 105 and 130 may pass the virtual circular line of an internal diameter corresponding to the internal end of the pad, which is in contact with the friction surface, by ½.

The present invention may be applied to and used for a carbon-ceramic disc so as to enable an operator to easily and accurately check a replacement time of the brake disc.

For convenience in explanation and accurate definition in the appended claims, the terms “upper”, “lower”, “inner”, “outer”, “up”, “down”, “upper”, “lower”, “upwards”, “downwards”, “front”, “rear”, “back”, “inside”, “outside”, “inwardly”, “outwardly”, “interior”, “exterior”, “inner”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A carbon-ceramic disc, which is provided with friction surfaces on both surfaces of a load part at a center of the disc, the carbon-ceramic disc comprising:
a wear indicating device formed on at least one of the friction surfaces, wherein a wear indicating recess as the wearing indicating device is formed along a virtual circular line between a contact surface of the disc contacting with a pad, and a non-contact surface of the disc not contacting with the pad in the carbon-ceramic disc.

2. The carbon-ceramic disc of claim 1, wherein the virtual circular line is formed on the at least one of the friction surfaces of the carbon-ceramic disc to pass through a center point of a width of the wear indicating recess.

3. The carbon-ceramic disc of claim 1, wherein the wear indicating recess is circularly formed along the virtual circular line between the contact surface and the non-contact surface of the pad in the at least one of the friction surfaces of the carbon-ceramic disc.

4. The carbon-ceramic disc of claim 1, wherein a plurality of wear indicating recesses are arranged along the virtual circular line between the contact surface and the non-contact surface of the pad in the at least one of the friction surfaces of the carbon-ceramic disc at a same interval.

5. The carbon-ceramic disc of claim 1, wherein the wear indicating recess is formed in any one shape selected from a quadrangular shape, a circular shape, and a triangular shape.

6. The carbon-ceramic disc of claim 1, wherein the wear indicating recess is formed with a depth of 30 to 40% of a thickness of the at elast one of the friction surfaces.

7. The carbon-ceramic disc of claim 6, wherein width of the wear indicating recess passes the virtual circular line between the contact surface of the pad, and the non-contact surface of the pad by ½.

8. The carbon-ceramic disc of claim 1, wherein the load part and the friction surfaces formed on both side surfaces of the loading part are formed of a composition of carbon and ceramic.

9. The carbon-ceramic disc of claim 8, wherein a ceramic concentration of the load part is larger than a ceramic concentration of the friction surfaces.

10. The carbon-ceramic disc of claim 9, wherein a carbon concentration of the friction surfaces is larger than a carbon concentration of the load part.
